(19) United States
(12) Patent Application Publication
(10) Pub. No.: US 2007/0214034 A1
(43) Pub. Date: Sep. 13, 2007

(54) Systems and methods for managing and regulating object allocations

(76) Inventors: Michael Ihle, Forst (DE); Frank Westendorf, Ubstadt-Weiher (DE); Luz Maerkle, Elztal (DE)

Correspondence Address: SAP / FINNEGAN, HENDERSON LLP, 901 NEW YORK AVENUE, NW, WASHINGTON, DC, 20001-4413, US

(21) Appl. No.: 11/511,219

(22) Filed: Aug. 29, 2006

Related U.S. Application Data
(60) Provisional application No. 60/712,089, filed on Aug. 30, 2005.

(51) Int. Cl. G06Q 10/00; G06F 15/02; G06F 9/46

(52) U.S. Cl. 705/9; 705/1

(57) ABSTRACT

Systems and methods are disclosed for the management and regulation of allocations of objects of a first entity to objects of a second entity, wherein the first entity and the second entity can in each case communicate via an interface with the system. In one exemplary embodiment, a system may comprise of at least a first register unit for registering the objects of the first entity by generating and filing allocation objects referencing the respective objects and a second register unit for registering the objects of the second entity by generating and filing business objects referencing the respective objects. The system may further comprise a segment unit for defining, generating and registering logic subsets of the business object, a first allocation unit in which allocations between allocation objects of the first register unit and logic subsets of the segment unit can be defined, generated and retrievably filed, and a second allocation unit in which allocations between business objects of the second register unit and logic subsets of the segment unit can be defined, generated and retrievably filed.

### RELATED APPLICATION

Under provisions of 35 U.S.C. § 119(e), this Application claims the benefit of U.S. Provisional Application No. 60/712,089, filed Aug. 30, 2005, which is expressly incorporated herein by reference to its entirety.

### BACKGROUND OF THE INVENTION

1. Field of the Invention

The present invention relates to systems and methods for managing and regulating allocations between object of various systems. More particularly, and without limitation, the present invention relates to systems and methods for managing and regulating allocations between objects of an inventory-controlling system and objects of a second system, according to predeterminable order criteria.

2. Background Information

Relationships and allocations between objects of various systems play an important role. In particular, in the business management sector, such as, for example, in the insurance sector, relationships and allocations between objects are important because existing allocations are often connected with various actions or the derivation of rights and obligations, such as for example in the case of insurances involving a calculation of commissions when an insurance contract is successfully concluded or the initiation of some other business process in systems connected therewith. Since allocations often exist between objects that belong to various systems and, therefore, the allocations often relate to a very heterogeneous system environment, as a result of which none of the systems take over or can take over the management and control of the allocations, it would be desirable, on account of the fact that apart from the actual objects it is specifically the allocations between the objects that can play an important role, to make available systems and methods that can basically take over a management and regulation of such allocations between objects of various systems. Such systems or methods should moreover be suitable for managing allocations of objects whose system affiliation varies greatly and that as a rule are in many cases not well defined. Accordingly, systems and methods are needed that have a very generic structure and are able to be integrated into such a heterogeneous system environment.

By way of example, WO 2004/079588 A1 discloses a know process for data allocation, in which data objects of an inventory are subdivided into segments, for which in turn allocations can be carried out on request via an intermediate unit. In this case, a segment allocation is realized that is available for calculations in a system, such as for example, in a commission system.

### SUMMARY OF THE INVENTION

According to one embodiment of the present invention, a system for the management and regulation of allocations of objects of a first entity to objects of a second entity is disclosed, wherein the first and the second entities may in each case communicate with the system via an interface. The system may include at least a first register unit for registering the objects of the first entity by generating and filing allocation objects referencing the respective objects, a second register unit for registering the objects of the second entity by generating and filing business objects referencing the respective objects, a segment unit for defining, generating and registering logic subsets of the business objects, a first allocation unit in which allocations between allocation objects of the first register unit and logic subsets of the segment unit can be defined, generated and retrievably filed, and a second allocation unit in which allocations between business objects of the second register unit and logic subsets of the segment unit can be defined, generated and retrievably filed.

The first entity may be, for example, a group of processors or organization units within a company, wherein the objects of the first entity are represented by the individual processors or by specific predefined groupings of processors or by organization units. For example, in the case of the insurance industry, the first entity may be a group of insurance agents or corresponding organization units of specialist clerks in an insurance company.

The second entity may be, for example, a system managing a specific inventory. This could be, for example, in the insurance industry, a system managing existing insurance contracts. The objects of the second entity would then be regarded as the insurance contracts. In this special case, an inventory should be understood as a number of insurance contracts, which are combined according to certain aspects to form an inventory.

In the case of the insurance industry, systems consistent with the present invention may make available a functionality, which with the aid of allocations of business objects to logic subsets, which are hereinafter termed segments, and allocations of the segments to allocation objects, permits an allocation and administration of business objects. In the case mentioned above, for example, this would represent insurance contracts, to so-called segment receivers, such as, for example, in the case mentioned above to commission contracts. Systems according to the invention may therefore be termed a so-called inventory allocation, which forms, regulates and manages business object allocations, i.e., bundles of business objects, to logic subsets, so-called segments, and furthermore forms, regulates and manages their respective allocation via a so-called segment allocation to a segment receiver. A business object may, as already mentioned, represent, for example, an insurance policy. An allocation object may in this connection represent for example a commission contract. A logic subset is termed a segment, and represents a logic subset of business objects. The allocations of business objects to segments are hereinafter termed business object allocations (BOA). The allocations of segments to allocation objects are hereinafter termed segment allocations (SA).

Accordingly, systems according to the present invention may enable allocations between objects of an inventory control system and further objects, such as for example commission contracts, to be formed and managed according to specific order criteria. All allocations are in this connection realized via segments, by means of the first and second allocation units.

In accordance with an embodiment, a system according to the present invention may consist of five components, which appropriately interact and thereby form allocations of objects of the first and second entities. In this connection it should be noted that the objects of the first entity as well as the objects of the second entity furthermore exist physically in the first and second entities, and can be represented and filed in the system according to the invention only by allocation objects and business objects referencing the respective objects. Accordingly, the logic subsets of the business objects and the so-called segments also do not consist of physically present objects but of business objects referencing the corresponding objects.

An allocation of business objects to segments may in this connection take place according to corresponding order criteria. The segment is a partial inventory of the business objects, which in turn represent objects of the second entity. Such a partial inventory of business objects may be defined, i.e., may be created according to certain order criteria. Such order criteria may for example be geographical, product-related, customer group-related, function-related order criteria, or may be combinations thereof. An inventory is, as already mentioned, an existing quantity of specific objects, for example of a company. The objects may be customers, contracts and/or products. An inventory can be subdivided according to specific business administration criteria, such as for example space, product lines or the like, into different partial inventories, which in turn is reflected by defining, generating and registering the segments of the business objects.

Methods can therefore be created in systems consistent with this invention in which business objects are allocated to segments and allocation objects are allocated to segments. In the narrower sense, or in the aforementioned special case of an insurance company, such methods may correspond, for example, to a transfer of a vacant inventory of insurance contracts to one or more new commission receivers. The vacant inventory of insurance contracts is in this case represented in systems according to the present invention first of all by a corresponding number of business objects. In addition, the inventory may be subdivided according to specified or selectable criteria into partial inventories, which corresponds to bundling the business objects into segments reflecting the partial inventories. The partial inventories may in this connection be split up, for example, according to regional affiliation of the insurance contract partners. The segments are then also built up correspondingly. The segments are now in each case allocated to an agent, i.e., a potential commission receiver, who is chosen as agent for a specific region. Systems according to the present invention thus may form in a detailed manner, in individual components, the resulting allocation structure.

In accordance with one embodiment, a method and system are provided according to the present invention, wherein at least one user interface is provided via which inputs, in particular object-specific and/or entity-specific data and queries, can be undertaken.

In this connection, it is possible for the definition, generation and/or registration of segments of the business objects in the segment unit to be modulated and/or controlled via the user interface. Furthermore, for example, so-called free segments can be selected and, in addition, new vacant allocation objects, such as, for example, commission contracts, can be allocated. A free segment means in this connection a segment which in addition could not be allocated to an allocation object.

This means that, apart from the modulation and control of the definition, generation and/or registration of segments, in a further embodiment of a system according to one embodiment of the present invention, it is possible via the user interface to influence and/or to control the definition, generation and filing of allocations between allocation objects of the first register unit and segments of the segment unit in the first allocation unit.

In this connection it is conceivable that inputs and/or queries via the user interface can be undertaken only by an authorized and authenticated user. This means that a reading and/or writing entitlement via the user interface and thus an influencing of the system can take place only in an authorized manner.

Systems according to one embodiment of the present invention can thus be influenced in a purposeful manner by the provision of at least one user interface. In this connection, it may be envisaged, by means of a menu provided in the user interface, to be able to look after, i.e. create, alter and display, segments; to be able to look after, i.e., again to create, alter and display allocations of business objects to segments, and to be able to look after, i.e., create, alter and display allocation of segments to allocation objects. A report specific to each menu point can in this connection be made available on the part of the system.

Systems according to one embodiment of the present invention may manage allocations between segments and business objects and allocation objects. As already mentioned these objects have their origin in other systems, i.e., in the first or second entity, from which they are appropriately notified to the system according to the present invention via the respective interface. The creation, alteration and cancellation of business objects and of allocation objects via the user interface that is made available may therefore be provided basically only for an exceptional case. A user may, for example, by himself create corresponding dialogues that can be conducted via the user interface. A corresponding documentation may be made available.

In another possible embodiment, a method according to the invention is provided wherein the user interface is available to a user via an external framework that can be connected to the system.

Systems according to one embodiment of the present invention may be fully decoupled from the first and second entities and is accordingly autarkic, but communicates with the first and second entities via corresponding interfaces. In this connection, it is possible for the first and/or second entity to communicate dynamically object-specific information to the system via the respective interfaces, and to be able to communicate in a reading and/or controlling manner with the system. Thus, for example, queries on the part of the first and/or second entity may be possible, for example, periodic over a specific timeframe. A system according to one embodiment of the present invention may consist of at least five components, which regulate the allocations and/or relationships of business objects to the allocation objects via segments, via two allocation units, so-called allocation roles. Further, the system may stand as a managing system for allocations between objects that are not originally handled in the system itself. The management of the corresponding objects as regards contents, in particular also their attributes, is the task of the connected systems, i.e., the first and second entities. On grounds of redundancy, it also does not appear expedient to manage object attributes in the objects intrinsic to the system.

In a further embodiment, a system according to the present invention is provided wherein the allocation objects to be registered in the first register unit references the objects of the first entity by means of an object type statement, an object identity number and an object origin statement.

In another embodiment, the business objects to be registered in the second register unit also reference the objects of the second entity by means of an object type statement, an object identity number and an object origin statement.

In both the aforementioned cases it is also possible to use in addition user-specific attributes for the respective referencing.

In the same way, it is conceivable to register the segments of the business objects in the segment unit likewise via a segment identification number and a segment type.

In this connection, it is moreover conceivable to file the allocations between business objects of the second register unit and segments of the segment unit in the second allocation unit in each case by stating the segment identification number, segment type, business object identification number, business object type and an allocation type and other selectable attributes that can be input in particular by a user.

In the same way, it is conceivable to file the allocations between allocation objects in the first register unit and segments of the segment unit in the first allocation unit in each case by stating the segment identification number, segment type, allocation object identity number, allocation object type and an allocation type and other selectable attributes that can be input in particular by a user.

The segment is a system-specific layer between the business object and allocation object. Systems according to the present invention can request via the respective interfaces information on the objects of the first and second entities, respectively, since these objects are to be managed in the system according to the invention, but are originally handled in the first and second entity, respectively. Basically in this connection there may be two types of information, which are transferred to the system according to the invention on the part of the connected first and second entity, respectively. On the one hand this information may be metadata information on the corresponding objects. In addition, it may be a data record/information record concerning the corresponding objects, which are predetermined for example as a “character string”.

When coupling systems according to the present invention to the first and second entities to be connected thereto, it must be ensured that for the management and regulation of the objects of the corresponding entities all three systems ultimately “speak the same language”. For this purpose, in a further embodiment of the present invention, a control unit may be explicitly provided that defines and controls the communication of the system with the first and second entities.

Thus, it may be possible for example that only selected allocations are possible or permitted between the objects of the first and second entities. Furthermore, it is conceivable that there is only one selection of defined allocations between objects of the first and second entities.

In the case where the second entity is, as already mentioned hereinbefore, a number of insurance contracts to be managed, and where the first entity is the staff processing and/or managing the insurance contracts, then, for example, four different allocation types are conceivable. On the one hand a settlement agent, an inventory handler, an adjustments agent and/or an extension agent may be involved in an insurance contract. Insurance clerks may be allocated to an insurance contract via these different types.

In addition, it is also conceivable to define different types of business objects. In the case of insurance contracts it is possible, for example, to distinguish four different business object types in the system according to the invention, such as, for example policy, contract, contract partial package, and contract part.

Via the corresponding interfaces it is now conceivable for the first and second entities to notify the system according to the present invention of the relevant object types and allocation types from the respective entity with regard to an envisaged integration scenario, which are then correspondingly filed in the system according to the present invention and are used to generate the allocations, the business objects, the allocation objects and the segments. These types now filed in the corresponding system according to the invention are known to the first and second entities, so that mechanisms can be provided in the first and second entities in order to copy the types employed in the respective entities to the types now filed in the system according to the invention. A communication of the first and second entities via the respective interfaces with the system according to the invention may in this connection be effected online, i.e., automatically at a suitable time, such as, for example, during an alteration of the number of the objects managed in the respective entities, or alternatively a communication can be periodically initiated at specific intervals.

It is understood that the embodiments discussed in more detail hereinbefore represent only examples of a possible use of a system according to the present invention, and obviously other object types and combinations are also possible when using systems according to the invention.

It is furthermore conceivable to provide business objects that are filed in the second register unit in the system according to the present invention with attributes, and to manage such objects in a version-dependent manner; in other words, an alteration of the objects of the second entity that form the basis of the business objects must be notified to the system according to the invention, so that the business objects referencing the corresponding objects can be consistently managed. A cancellation of an object to which reference is made via a business object in the system according to the invention can also be notified to the system according to the invention, and the corresponding business object can there be characterized as deleted.

As already mentioned, it is possible via a user interface made available on the part of the system according to the invention to read filed allocation constellations represented in the system according to the invention. In the case of an insurance company it is conceivable, for example, to read the inventory of a specific agent. At the same time it is conceivable that the system according to the invention prepares a report with which the inventory allocation information can be read starting from a specific target date.

In order to effect a synchronization between the first and second entities and the system according to the invention, it is conceivable for the system according to the invention to provide a so-called report, with which a synchronization of version-guided business object data, for example, can be effected. The so-called report then transfers the identity numbers of the objects managed in the system according to the invention and the date of the latest state of knowledge, in the form of a table to the corresponding entity. In response to this a table containing entries concerning the changes to the listed objects made from this time on is prepared by the corresponding entity via the corresponding interface.

In systems according to the present invention, the first and second entities to be connected can be configured via a corresponding identification of the corresponding entities. In this way, it is possible to configure a system according to the invention completely decoupled from the entities to be connected, and to connect these via corresponding interfaces to the system according to the invention.

A further example is the case of partnerships, the detailed infrastructure of which can likewise be regulated and managed by a system according to the present invention.

Apart from the already mentioned management functionalities, which as a rule are triggered from outside, i.e., via a user through a user interface or via the first and/or second connected entity, the system according to the present invention can in a further embodiment provide functionalities with regard to processes operated by the system itself, for the creation, alteration and termination of objects and allocations of these objects among one another. Such functionalities are then appropriately connected to the five components of the system according to the present invention. With the aid of these functionalities it is possible for a user to deal individually and in an object-specific manner with changes in the five basic components.

As has already been mentioned hereinbefore, it may be possible to care for and look after segments via the user interface provided in an embodiment of the system according to the present invention. The care of segments consists of an arrangement, an alteration including a termination, and a display of segments. The care is independent of allocations of business objects to segments and of the allocation of segments to allocation objects. In this connection dedicated windows with corresponding function icons may be made available for the care of the segments. It is possible for the display of segments or for the implementation of a change via corresponding icons a selection of segments. In the selection of segments it is also possible, for example, to select segments that for example are not allocated to an allocation object. In the case of insurance contracts this would be, for example, a segment in which insurance contracts are combined that have not been allocated to an insurance agent.

Apart from the care of segments it is also conceivable that, via the user interface that is made available in an embodiment of a system according to the present invention, a care of allocations of business objects to segments is possible that again consists of a creation of a new allocation, an alteration of an existing allocation including a deletion, and a display.

Similarly it is conceivable in yet a further embodiment of the invention that a care of allocations of segments to allocation objects is possible via the user interface that is made available. In this connection, the care of the allocation of segments to allocation objects again likewise involves a creation of a new allocation, an alteration, and a display of existing allocations.

In addition, it may be possible in a further embodiment of the system according to the present invention to provide navigation possibilities via the user interface that is made available. It is, for example, possible by double-clicking to jump between an allocation of business objects to segments, and an allocation of segments to allocation objects. The following scenario may serve to illustrate this.

A segment “4711” should, as far as business object “A,” which is to be newly allocated to a segment “4812”, no longer be allocated to an allocation object 10 but should be newly allocated to an allocation object 11. This is therefore an alteration of two allocations in the same context, which have to be accommodated via two different menu points in the user interface. In order to simplify the execution of such a procedure, the possibility is provided of navigating the allocation of segments to allocation objects for the allocation of business objects to segments. It may, for example, be envisaged that by double-clicking on the segment identification number, a jump can be made from the displayed allocation of segment “4711” to the allocation object 10, to the allocation of business objects to the segment “4711.” The information regarding segment type and segment identity number are in this connection picked up by the “jump point,” so that the allocated business objects are displayed immediately. Here the business object “A” can be newly allocated to the segment “4812.” The previously displayed allocation of segments to allocation objects is reached again by jumping back. By jumping backwards and forwards a so-called “popup” can also appear, asking whether the previously input alterations are to be saved. If the user answers this question in the affirmative, then the previously altered data are saved in a corresponding databank of the system according to the invention. Conversely, it may be possible to jump, by double-clicking, from an allocation of business objects to segments, to a segment identity number in an allocation of segments to allocation objects, so as to display or alter there the allocations of the segment.

An implementation of user individual selections may be made possible by suitable separate selection options on a screen of the user interface that is made available, so that corresponding selections can be made.

According to embodiments of the present invention, the allocation between objects of the first entity and the second entity takes place via a respective segment filed in the segment unit. In this connection, various segment types can be distinguished. A segment type categorizes segments, i.e., logical subsets of business objects of an inventory with specific manifestations. Each segment type represents a specific approach to the inventory. Depending on the approach, an inventory can be split up, for example, according to the following order criteria: geographically; product-related; customer group-related; function-related, or according to other combinations. A product-related segment type is, for example, a subdivision according to products along specific product lines. A geographical segment type exists if, for example, customers are subdivided according to operating regions. A segment allocation documents an allocation between a segment and an allocation object, such as, for example, a commission contract. A so-called segment allocation role specifies in this connection the nature of the allocation between commission contract and segment, i.e., whether, for example, an additional commission case is triggered or not. A segmentation carried out with the system according to the present invention describes an administrative procedure for the modeling of segments. The purpose of a segment is, as already mentioned, to carry out an ordered bundling of business objects. Thus, business objects can be bundled according to postcode, product group, etc., or alternatively business objects can be bundled as regards their handling by a responsible agent.

In addition, embodiments of the present invention relate to methods for the management and regulation of allocations of objects, such as, for example, of commission contracts or agents, of a first entity to objects, such as insurance contracts, of a second entity, wherein the first entity and the second entity can communicate in each case with a regulation system switched between the first and the second entities. In a method according to one embodiment of the present invention, the objects of the first entity are registered in a first register unit of the regulation system by creating and filing allocation objects referencing the respective objects of the first entity, and the objects of the second entity are registered in a second register unit of the regulation system by generating and filing business objects referencing the respective objects of the second entity. In addition, logic subsets of the business objects are defined and generated, and registered as segments in a segment unit of the regulation system. Allocations between allocation objects and segments of the segment unit and allocations between business objects and segments of the segment unit are defined, generated, and retrievably filed.

In one embodiment of a method according to the present invention, at least one user interface is made available, via which inputs, in particular object-specific and/or entity-specific data and queries can be carried out.

In a further possible embodiment of a method according to the present invention, the definition, generation and/or registration of segments of the business objects are modeled and/or controlled in the segment unit via the user interface.

Furthermore, it is conceivable that the definition, generation and filing of allocations between allocation objects of the first register unit and segments of the segment unit in the first allocation unit are influenced and/or controlled via the user interface.

It is also possible that before or during inputting and/or queries an authorization and authentication check of the user is carried out on the part of a user via the user interface.

According to a further embodiment of a method according to the present invention, the user interface is made available via an external framework that can be connected to the system.

According to another embodiment of a method according to the present invention, the first entity and/or the second entity can deliver object-specific information dynamically to the regulation system via the respective interfaces, and in addition can communicate in a reading and/or controlling manner with the system. This means that the first and second entities can execute queries, for example, periodically. Queries executed in this way can, for example, relate to a specific timeframe.

It is conceivable that the allocation objects to be registered in the first register unit reference by means of an object type statement, an object identity number and an object origin statement, the objects of the first entity.

Likewise, it is possible that the business objects to be registered in the second register unit reference by means of an object type statement, an object identity number and an object origin statement, the objects of the second entity.

According to a further embodiment of a method according to the present invention, user-specific attributes are additionally used for the respective referencing.

Furthermore it is possible that the logic subsets, i.e., the segments in the segment unit, are registered via a segment identity number and a segment type.

In another embodiment of a method according to the present invention, the allocations between business objects of the second register unit and segments of the segment unit in the second allocation unit are filed in each case with a statement of the segment identity number, segment type, business object identity number, business object type and an allocation type, and other selectable attributes that can be input in particular by a user.

Furthermore, it is possible that the allocations between allocation objects of the first register unit and segments of the segment unit in the first allocation unit are filed in each case with a statement of the segment identity number, segment type, allocation object identity number, allocation object type and an allocation type, and other selectable attributes that can be input in particular by a user.

Furthermore, a control unit can be provided that defines and controls the communication of the system with the first and second entities.

Furthermore, an adapter unit can be provided in which object types and role types collated with the first and second entities can be filed for corresponding allocations, and with the help of which the objects of the first entity, the objects of the second entity and corresponding allocations for the individual units of the system can be made processable.

Other embodiments of the present invention relate to computer programs with program coding means in order to carry out all steps of methods consistent with the invention when the computer program is run on a computer or a corresponding computing unit.

Additional embodiments of the present invention relate to computer program products with program coding means that are stored on a computer-readable data carrier in order to carry out methods consistent with the invention when the computer program is run on a computer or a corresponding computing unit.

Further advantages and modifications of the invention follow from the description and the accompanying drawings.

Additional aspects of the invention are set forth in the detailed description that follows or may be learned by practice of methods, systems, and articles of manufacture consistent with the present invention. It is understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several aspects of the invention and, together with the description, serve to explain the principles of the invention. In the drawings:

FIG. 1 is a diagrammatic representation of an architecture in which an exemplary regulation system according to an embodiment of the invention is arranged and embedded between two entities;

FIG. 2 is another diagrammatic representation of a system architecture in which an exemplary regulation system according to another embodiment of the present invention is provided;

FIG. 3 illustrates an internal structure of an exemplary regulation system according to an embodiment of the present invention; and

FIG. 4 illustrates a more detailed structure of a further exemplary regulation system according to an embodiment of the present invention.

### DETAILED DESCRIPTION

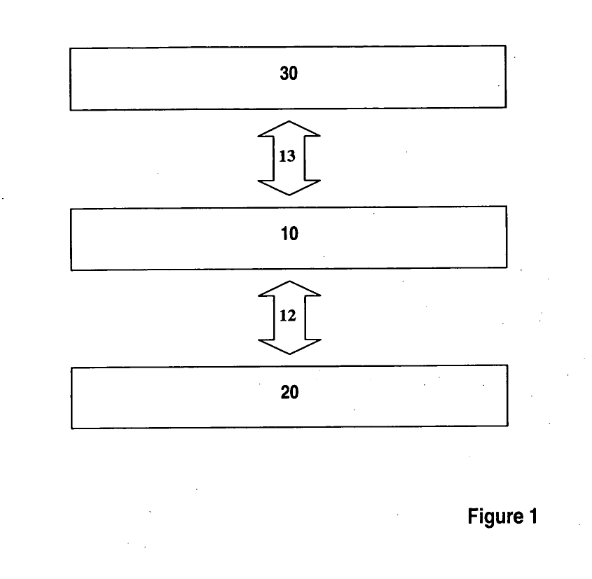

FIG. 1 is a diagrammatic representation of an architecture of an exemplary regulation system 10 according to one embodiment of the present invention. As shown in FIG. 1, system 10 is embedded between two entities 20 and 30. Further, regulation system 10 is coupled via a first interface 12 to the first entity 20, and via a second interface 13 to the second entity 30. Information concerning the first entity 20, as well as the second entity 30, can flow into the regulation system 10 via the respective interfaces 12 and 13, wherein corresponding allocations of objects of the first entity 20 to objects of the second entity 30 can then be permanently specified, filed and made reproducible. Such allocations may in this connection be undertaken under various aspects, i.e., allocation groupings may be formed and the objects are coupled via so-called segments. The second entity 30 may be, for example, a so-called inventory system, in which an inventory, i.e., an existing quantity of specified business objects, such as for example, customers, contracts or products of a company, are filed. An inventory can be subdivided into various partial inventories according to specific business administration criteria, such as space or product lines.

In one embodiment, the objects of the inventory system are filed in the regulation system 10 as business objects referencing the objects of the inventory system, and are managed as it were as virtual objects. Objects of the second entity 30 correspond to objects such as, for example, commission contracts or business partners or insurance agents. In the exemplary regulation system 10, the objects of the second entity 30 can be bundled in the form of segments. The segments can then in turn be allocated to objects of the first entity 20. The correspondingly characteristic allocation types between objects of the first entity and objects of the second entity to the respective segments can be filed, reproduced and characterized in the regulation system 10. In this connection, it is conceivable that the first and the second entities as well as the regulation system 10 in each case form autarchic systems, which can then correspondingly communicate with one another via suitable interfaces 12 and 13. The regulation system 10 must be appropriately configured corresponding to the first and second entities.

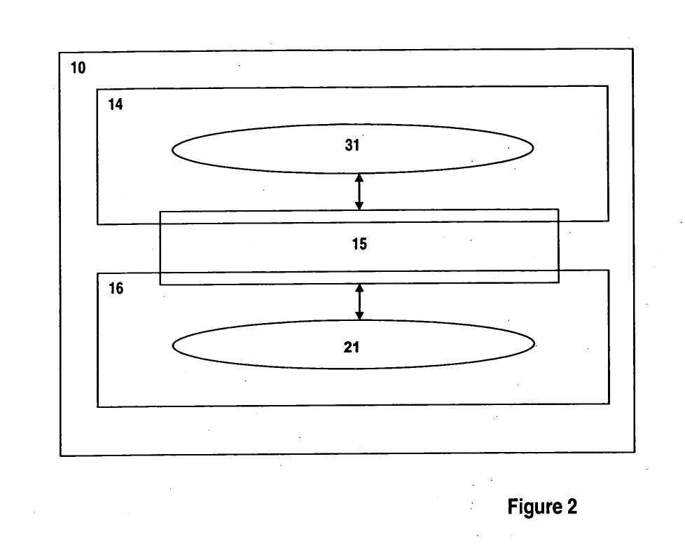

FIG. 2 is a diagrammatic representation of another exemplary regulation system 10 according to an embodiment of the present invention. As shown in FIG. 2, system 10 may facilitate allocations between objects of a first entity and objects of a second entity. The objects of the first entity may be filed in the regulation system 10 as allocation objects 21 referencing the objects of the first entity. The objects of the second entity may be filed in the regulation system 10 as business objects 31 referencing the objects of the second entity. The first entity may, for example, be a system for managing commissions or for managing so-called master data, such as, for example, business partners, commission contracts and also organization structures and marketing structures. The second entity may, for example, be a so-called inventory system. In this connection, it may be a product-operating regulation system for insurance systems.

The regulation system 10 may serve to reproduce various possible allocations between objects of the second entity and objects of the first entity, and to manage, reproduce and file allocations of business objects via so-called segments to corresponding segment receivers and allocation objects, respectively. In addition, it may be possible here to generate and modulate segments, and to file user-specific attributes.

It is conceivable, for example, that the allocation object 21 references a commission contract “1000,” i.e., an object filed in the first entity. This commission contract “1000” can now be associated with or coupled to a specific insurance contract “4711,” which is filed in the second entity. This insurance contract “4711” is reproduced as business object 31 in the regulation system 10. On the one hand, the insurance contract “4711” can now be allocated directly to the commission contract “1000.” On the other hand, a two-stage allocation may, however, also take place, namely an allocation via a suitable segment 15, which, for example, bundles all insurance contracts for which an agent, who is in turn coupled to the commission contract “1000,” is responsible. If the agent is responsible, for example, for the insurance inventory “Region: Munich,” then the segment 15 bundles all the business objects referencing the corresponding insurance contracts of the insurance inventory “Region: Munich” of the second entity. If the insurance contract “4711” likewise falls in this insurance inventory, then the business object 31 that refers to the insurance contract “4711” is also allocated to the segment 15 via a so-called business allocation (BA). The allocation object 21 that refers to the commission contract “1000” associated with the agent is then likewise allocated to the segment 15 via a so-called segment allocation (SA), so that ultimately although the allocation object 21 is connected via the segment 15 to the business object 31, nevertheless both the segment 15 as well as the business allocation and the segment allocation simultaneously permit via the stepwise allocation a detailed and specific outcome and also a decoupling of the allocation. A business object can be grouped together with other business objects according to specified conditions in the segment 15, independently of allocation objects associated therewith. This corresponds to an already mentioned, so-called business allocation. Thus, segments can be formed via all objects filed in the second entity, that bundle the objects of the second entity according to specific objective aspects. All business objects of a segment have a common characteristic. An allocation object referencing an object of the first entity, such as, for example, the commission contract “1000”, can then in turn be allocated to a specific segment 15.

In accordance with one embodiment, the following procedure may be implemented. Free inventories not allocated to an agent are allocated to new segments according to business and political aspects, such as, for example, according to regions and/or product lines, so that these can be explicitly allocated at a later time to an agent, i.e., to an intermediary or case handler. An intermediary may in this connection assume various roles in a company. The roles that an intermediary “A” can assume within the framework of his intermediary activities for a company “U” is specified contractually. If an insurance inventory, i.e., a segment, is not allocated at the beginning to the intermediary “A,” then at this point in time no allocations are possible via the regulation system 10. If a free insurance inventory is allocated to the intermediary “A” immediately at the start of his involvement in the insurance, then this insurance inventory, which is formed in the regulation system 10 by one or more segments, can be allocated a corresponding commission contract, namely that of the intermediary “A.” If the intermediary “A” sells insurance policies of the company, then after successful conclusion of a policy deal the business allocations of the policies are updated corresponding to the segment. With a successful handling of a new insurance policy this should be allocated to the partial inventory of an intermediary “A.” If an insurance company operates an assigned territory and/or customer system, the corresponding partial inventory can be established via a regulatory apparatus with the corresponding information.

Participatory percentages, such as, for example, for direct or indirect commissions for possible future commission cases, such as consequential commission cases for extensions of insurances or a dynamic adjustment in the case of life insurance policies, can also be stored in the regulation system 10 so that they can subsequently be reused. If technical alterations to a policy should arise, such as extension, increased contributions or dynamic adjustment, then the corresponding participation percentages that were then stored in the regulation system 10 may be required for these determined commission cases.

If an insurance inventory is conditionally allocated to a new intermediary “B,” it may happen that the allocation of the previous intermediary “A” still exists. If the new intermediary “B” effects a change in an insurance policy, this policy is allocated to its inventory, i.e., to its partial segment. Such conditional or provisional inventory allocations may, for example, in some cases also be for a fixed term. If, for example, technical changes are made to a policy, such as extensions, increased contributions or dynamic adjustments, then possibly the corresponding participation percentages that are stored in the regulation system 10 are required for the commission cases to be newly determined. The regulation system 10 accordingly contains information on the participatory percentages, so-called split rates, for direct and indirect remunerations, which in connection with an inventory and its segment allocation to an allocation object, i.e., to an intermediary or to a commission contract, are filed in the regulation system 10. Such changes may be taken care of in the regulation system 10 via a dialogue or may also take place periodically via corresponding global changes in the so-called batch.

If an insurance policy is terminated, the corresponding segment or partial segment associated with the insurance policy must be adjusted in the regulation system 10. In the case where information has to be given to a current intermediary dealing with a policy, the intermediary can be specified via a user interface appropriately made available by the regulation system 10, through the regulation system 10 and via the insurance policy-segment-commission contract route, since exactly one such a representation is made available via the regulation system 10. The regulation system 10 can, therefore, serve to form and provide a corresponding infrastructure on request. Such a provision of infrastructures in connection with insurance policies and commission contracts associated therewith may be desired in various situations, such as, for example, where correspondence is generated or a periodic commission is paid on the basis of a segment or on the basis of a policy.

Accordingly, any types of allocations and their changes can be reproduced and filed, and displayed on request in the regulation system 10. By generating segments an allocation can be subdivided into two allocations separate from one another, namely a so-called business allocation, in which a business object is allocated to one or more segments, and a segment allocation, in which an allocation object is allocated to one or more segments. By means of such a subdivision it is possible to classify the corresponding allocations more precisely and thereby enable more detailed enquires to be made. Independently of the possibility of two separate types of allocation illustrated and described here, the degree of freedom can be raised as desired by establishing suitable further roles in the allocations.

In addition, so-called evaluation tools can be made available for an analysis of a current inventory allocation on the part of the regulation system 10. It is possible via such an evaluation tool to raise specific queries as regards filed data, such as for example with regard to a specific intermediary and his activity over a certain time. All other types of queries relating to a specific inventory and a specific time are thus conceivable.

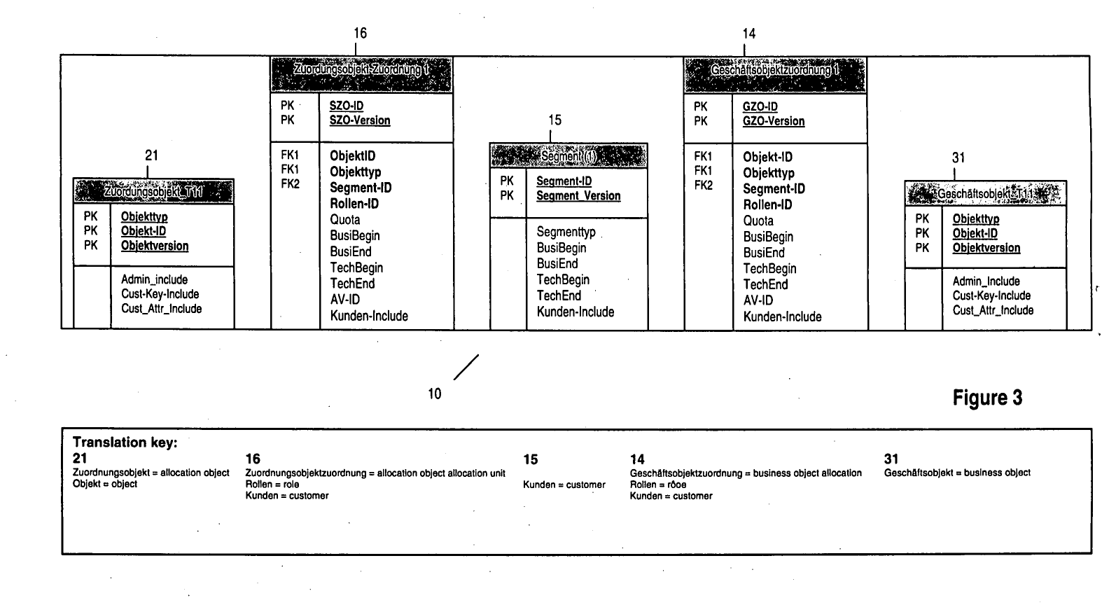

FIG. 3 illustrates an exemplary regulation system 10 with the basic components from which the regulation system 10 is built-up, consistent with an embodiment of the present invention. An allocation object 21 is shown, which is allocated via an allocation object allocation unit 16 to a segment 15. In addition, a business object 31 is allocated to the segment 15 via a business object allocation unit 14. These five components form allocations of business objects to allocation objects via segments through two so-called allocation roles.

The allocation object 21 references in this connection an object filed in a first entity, such as, for example, a commission contract or an intermediary or an organization unit within a company. The object that is represented by the allocation object 21 is referenced via a so-called object type, an object identity number (Object ID) and an object version. Apart from these three items of information regarding the object to be referenced, it is also possible on the part of a user to give further object-specific attributes. In addition keys may also be predetermined by the customer. It is also conceivable to provide further management-specific information for the management within the regulation system 10.

A so-called segment allocation identity number (SA-ID) and a segment allocation version (SA-Version) are filed in the allocation object allocation unit 16 that describes the allocation and the relationship between the allocation object 21 and segment 15. In addition, the corresponding object identity number (Object-ID), the object type and, on the part of the segment, a segment identity number (Segment-ID) are filed in order to characterize the object 21 associated with the segment 15. In addition, an identity number as regards an allocation role, i.e., a type identification of the allocation under a role-ID, is filed. Further attributes are conceivable. In this case, it is possible to specify timeframes or a time at which the specific allocation is started or completed or will be completed. Here too it is possible to add further attributes on the part of a customer or user, which are displayed if a corresponding query is made.

The segment 15 is likewise filed with a segment identity number (Segment-ID) and a segment version. In addition, a segment type is specified. Corresponding to the details that can be actuated for the allocation object allocation unit 16, details can also be filed together with the segment 15.

The business object allocation 14 is likewise characterized via a business allocation identity number BA-ID and a business object allocation version BOA-version. Furthermore, also the object relating to the business object allocation is characterized by an object-ID and an object type, and the affected segment 15 is similarly filed via a segment-ID. Furthermore, a role-ID is specified for the identification of the allocation type. Apart from these data similar information can optionally be filed, such as can be made available in the allocation object allocation unit 16.

The business object 31 is likewise characterized via an object-ID characteristic of the object to be referenced, and an object type, as well as an object version. Here, too inputs regarding a key or further attributes are possible on the part of the customer.

By means of the regulation system 10 it is possible via a suitably provided user interface to interrogate such tables, whereby an accurate representation of a specific allocation of an allocation object via an allocation object allocation unit to a segment and further via a business object allocation unit to a business object, can be provided and displayed. The regulation system 10 may exist as a managing system for allocations between entities that are not originally managed in the regulation system. Accordingly, it is sufficient in regard to a pure data management for the regulation system 10 simply to have a knowledge of the type, identity number and system origin of the objects to be managed. A contents-type management of these objects, in particular their attributes, is the task of the connected system. Object attributes are, for reasons of redundancy, preferably not managed in the regulation system-specific objects, namely in allocation objects and business objects.

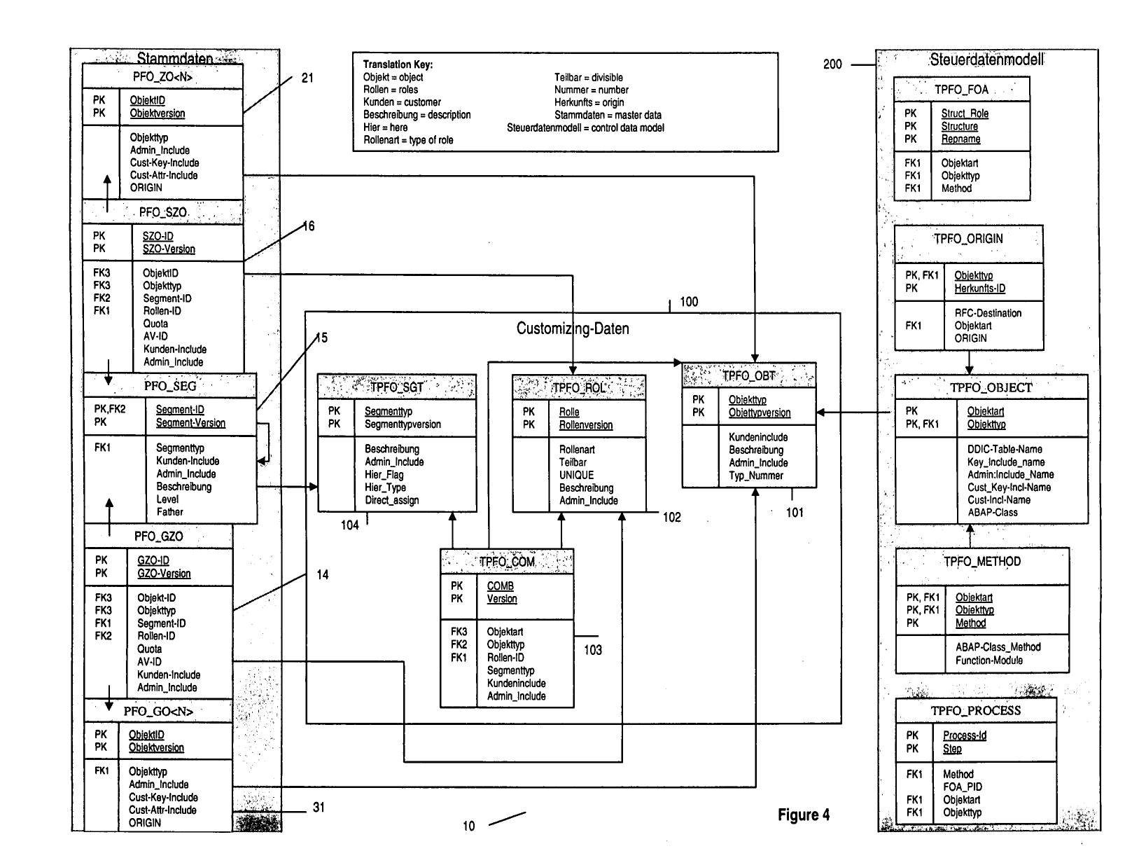

FIG. 4 is a detailed representation of an architecture of an exemplary regulation system 10 according to another embodiment of the present invention. The five basic components of the regulation system 10 are again shown on the left-hand side, namely an allocation object 21 that references an object of a first entity, which object is displayed by an object identity number (Object-ID) and an object version. An object type is also given. Furthermore, attributes may be filed. In addition, an allocation object allocation unit 16 is shown that couples the allocation object 21 to a segment 15. The allocation object allocation unit 16 is in turn characterized by a so-called allocation object allocation-ID and an allocation object allocation version. Together with the allocation object allocation unit an object-ID, an object type and a segment-ID and a role-ID are also filed, which specify the allocation between the allocation object 21 and the segment 15. The segment 15 is in turn characterized by a segment-ID and a segment version; furthermore a segment type is filed. Further attributes, such as, for example, user-specific attributes, may be added. In addition, a business object 31 is shown that is in turn characterized by an object-ID and an object version, which represent the object of a second entity to be referenced by the business object. Furthermore, an object type is filed and further attributes may be added. The business object 31 is connected via a business object allocation 14 to the segment 15. The business object allocation 14 is characterized via a business allocation-ID and a business allocation version. Furthermore, an object-ID and an object type are filed together with the business object allocation 14, which represent the object of the second entity to be referenced, and a segment-ID and a role-ID are also given.

A further building block of the regulation system 10 is illustrated in the central region, namely the building block 100 in which are filed the types of objects, segments and allocations that are possible. Object types, both with respect to the allocation object 21 as well as with respect to the business object 31, are filed in a component 101. Here details of which types of objects are involved can be given and filed. These may be, for example, intermediaries, policies or other types of objects, for which allocations are to be activated in the regulation system via intermediate coupling of segments. The component 102 furthermore predetermines a type of allocations and the component 103 predetermines which allocations are to be permitted at all within the scope of the relevant scenario. Finally, the component 104 specifies what types of segments are possible, i.e., how business objects can be grouped. The component 200 of the regulation system 10 that is also shown corresponds to the part of the regulation system 10 in which corresponding configurations are effected, in order to permit a communication via suitable interfaces with external entities, the respective objects of which are to be mapped among each other and retrievably filed within the regulation system 10 together with corresponding allocations.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A system for the management and regulation of allocations of objects of a first entity to objects of a second entity, the system comprising:
a first register unit for registering the objects of the first entity by generating and filing allocation objects referencing the respective objects;
a second register unit for registering the objects of the second entity by creating and filing business objects referencing the respective objects;
a segment unit for defining, generating and registering logic subsets of the business objects;
a first allocation unit in which allocations between allocation objects of the first register unit and logic subsets of the segment unit can be defined, generated and retrievably filed; and
a second allocation unit in which allocations between business objects of the second register unit and logic subsets of the segment unit can be defined, generated and retrievably filed.

2. The system according to claim 1, further comprising at least one user interface via which inputs and queries can be handled.

3. The system according to claim 2, wherein the definition, generation and/or registration of logic subsets of the business objects in the segment unit can be modelled and/or controlled via the user interface.

4. The system according to claim 2, wherein the definition, generation and filing of allocations between allocation objects of the first register unit and logic subsets of the segment unit in the first allocation unit can be influenced and/or controlled via the user interface.

5. The system according to claim 2, wherein the inputting and/or queries can be handled only by an authorized and authenticated user via the user interface.

6. The system according to claim 2, wherein the user interface is made available via an external framework that can be connected to the system.

7. The system according to claim 1, wherein the first and/or the second entity can supply object-specific information dynamically to the system via a respective interface and can communicate in a reading manner and/or controlling manner with the system.

8. The system according claim 1, wherein the allocation objects to be registered in the first register unit reference the objects of the first entity based on an object type specification, an object identity number and an object origin specification.

9. The system according to claim 1, wherein the business objects to be registered in the second register unit reference the objects of the second entity based on an object type specification, an object identity number and an object origin specification to.

10. The system according to claim 8, wherein user-specific attributes are additionally used for the respective referencing.

11. The system according to claim 2, wherein the logic subsets are registered in the segment unit as segments with a segment identification number and a segment type.

12. The system according to claim 10, wherein the allocations between business objects of the second register unit and logic subsets of the segment unit in the second allocation unit are in each case filed with details of the segment identification number, segment type, object identification number, object type and an allocation type, and other selectable attributes that can be input by a user.

13. The system according to claim 10, wherein the allocations between allocation objects of the first register unit and logic subsets of the segment unit in the first allocation unit are in each case filed with details of the segment identity number, segment type, object identity number, object type and an allocation type, and other selectable attributes that can be input by a user.

14. The system according to claim 2, further comprising:
a control unit that defines and controls the communication of the system with the first entity and the second entity.

15. The system according to claim 2, further comprising:
an adapter unit in which object types and role types collated with the first entity and the second entity can be filed for corresponding allocations, and with the aid of which the objects of the first entity, the objects of the second entity and corresponding allocations can be made processable for the individual units of the system.

16. A method for the management and regulation of allocations of objects of a first entity to objects of a second entity, wherein the first entity and the second entity can in each case communicate with a regulation system, the method comprising the steps of:
registering the objects of the first entity by generating and filing allocation objects referencing the respective objects of the first entity, in a first register unit of the regulation system;
registering the objects of the second entity by generating and filing business objects referencing the respective objects of the second entity, in a second register unit of the regulation system;
defining, generating, and registering logic subsets of the business objects in a segment unit of the regulation system;
defining, generating and retrievably filing allocations between the allocation objects and the logic subsets in a first allocation unit of the regulation system; and
defining, generating, and retrievably filing allocations between the business objects and the logic subsets in a second allocation unit of the regulation system.

17. The method according to claim 16, further comprising providing at least one user interface via which inputs, including object-specific and/or entity-specific details and queries, can be handled.

18. The method according to claim 17, wherein the defining, generating and/or registering of logic subsets of the business objects in the segment unit are modelled and/or controlled via the user interface.

19. The method according to claim 17, wherein the defining, generating and filing of allocations between allocation objects of the first register unit and logic subsets of the segment unit in the first allocation unit are influenced and/or controlled via the user interface.

20. The method according to claim 17, wherein an authorization and authentication check of the user is carried out before or during the inputting and/or queries via the user interface on the part of a user.

21. The method according to claim 17, wherein the user interface is provided via an external framework connected to the system.

22. The method according to claim 16, wherein the first and/or the second entity supply object-specific information dynamically via a respective interface to the regulation system, and communicate in a reading and/or controlling manner with the system.

23. The method according to claim 16, wherein the allocation objects to be registered in the first register unit reference the objects of the first entity based on an object type specification, an object identity number and an object origin specification.

24. The method according to claim 16, wherein the business objects to be registered in the second register unit reference the objects of the second entity based on an object type specification, an object identity number and an object origin specification.

25. The method according to claim 23, wherein user-specific attributes are additionally used for the respective referencing.

26. The method according to claim 16, wherein the logic subsets are registered in the segment unit as segments with a segment identification number and a segment type.

27. The method according to claim 26, wherein the allocations between business objects of the second register unit and logic subsets of the segment unit in the second allocation unit are filed in each case with details of the segment identity number, segment type, object identity number, object type and an allocation type, and other selectable attributes that can be input by a user.

28. The method according to claim 26, wherein the allocations between allocation objects of the first register unit and logic subsets of the segment unit in the first allocation unit are filed in each case with details of the segment identity number, segment type, object identity number, object type and an allocation type, and other selectable attributes that can be input by a user.

29. The method according to claim 16, further comprising providing a control unit that defines and controls the communication of the regulation system with the first entity and the second entity.

30. The method according to claim 16, further comprising providing an adapter unit in which object types and role types matched to the first and second entities can be filed for corresponding allocations, and with the aid of which the objects of the first entity, the objects of the second entity and corresponding allocations can be made processable for the individual units of the regulation system.

31. A computer program product including program coding means for carrying out the steps of a method according to claim 16 when the program coding means is executed by a processor unit.
